(19) United States
(12) Patent Application Publication
(10) Pub. No.: US 2021/0346739 A1
(43) Pub. Date: Nov. 11, 2021

(54) FALL-PROTECTION ASSEMBLY COMPRISING A SOFT, ENDLESS CONNECTOR

(71) Applicant: 3M INNOVATIVE PROPERTIES COMPANY, St. Paul, MN (US)

(72) Inventors: Stephen D. Shaver, Cottage Grove, MN (US); Nathan W. Safe, Red Wing, MN (US); Peter L. Olson, St. Paul, MN (US)

(21) Appl. No.: 17/268,702

(22) PCT Filed: Sep. 18, 2019
(86) PCT No.: PCT/IB2019/057879

§ 371 Date: Feb. 16, 2021

Related U.S. Application Data
(60) Provisional application No. 62/737,214, filed on Sep. 27, 2018.

(51) Int. Cl. A62B 35/04; A62B 35/00

(52) U.S. Cl. CPC A62B 35/04; A62B 35/0075

(57) ABSTRACT

A fall-protection assembly comprising a lanyard and a rigid fastener that are connected to each other by a soft, endless connector that is non-removably connected to the lanyard and that is removably connected to the rigid fastener.

### BACKGROUND

Fall-protection apparatus such as e.g. lanyards have often found use in applications such as building construction and the like.

### SUMMARY

In broad summary, herein is disclosed a fall-protection assembly comprising a lanyard and a rigid fastener that are connected to each other by a soft, endless connector that is non-removably connected to the lanyard and that is removably connected to the rigid fastener. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a perspective view of an exemplary lanyard with a first end with an exemplary soft, endless connector non-removably connected thereto, and of an exemplary rigid fastener to which the soft, endless connector can be removably connected to form a fall-protection assembly.

FIG. 2 is a magnified perspective view of the first end of the exemplary lanyard of FIG. 1.

FIG. 3 is a view of the first end of the exemplary lanyard of FIG. 1, showing a portion of the soft, endless connector having been passed through a captive eye of the exemplary rigid fastener.

FIG. 4 is a perspective view illustrating the act of passing a second end of an exemplary lanyard through an accessible opening of an exemplary soft, endless connector to form a hitch.

FIG. 5 is a perspective view showing an exemplary soft, endless connector hitched to an exemplary rigid fastener.

FIG. 6 is a perspective view of an exemplary fall-protection assembly comprising first and second lanyards.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as “top”, bottom”, “upper”, lower”, “under”, “over”, “front”, “back”, “outward”, “inward”, “up” and “down”, and “first” and “second” may be used in this disclosure, it should be understood that those terms are used in their relative sense only unless otherwise noted. In particular, in some embodiments certain components may be present in interchangeable and/or identical multiples (e.g., pairs). For these components, the designation of “first” and “second” may apply to the order of use, as noted herein (with it being irrelevant as to which one of the components is selected to be used first).

As used herein as a modifier to a property or attribute, the term “generally”, unless otherwise specifically defined, means that the property or attribute would be readily recognizable by a person of ordinary skill but without requiring a high degree of approximation (e.g., within +/−20% for quantifiable properties). The term “substantially”, unless otherwise specifically defined, means to a high degree of approximation (e.g., within +/−10% for quantifiable properties). The term “essentially” means to a very high degree of approximation (e.g., within plus or minus 2% for quantifiable properties; it will be understood that the phrase “at least essentially” subsumes the specific case of an “exact” match. However, even an “exact” match, or any other characterization using terms such as e.g. same, equal, identical, uniform, constant, and the like, will be understood to be within the usual tolerances or measuring error applicable to the particular circumstance rather than requiring absolute precision or a perfect match. The term “configured to” and like terms is at least as restrictive as the term “adapted to”, and requires actual design intention to perform the specified function rather than mere physical capability of performing such a function. All references herein to numerical parameters (dimensions, ratios, and so on) are understood to be calculable (unless otherwise noted) by the use of average values derived from a number of measurements of the parameter, particularly for the case of a parameter that is variable.

### DETAILED DESCRIPTION

As illustrated in exemplary embodiment in FIG. 1, disclosed herein is a lanyard 10 comprising a first, forward end 11 with a soft, endless connector 100 non-removably connected thereto. Soft, endless connector 100 can be removably connected to a rigid fastener 200 (e.g. to a rigid member 202 that at least partially defines a captive eye 201 of the rigid fastener 200) to connect first end 11 of lanyard 10 to a rigid fastener 200 as described in detail later herein. Soft, endless connector 100 thus allows lanyard 10 and rigid fastener 200 to be connected to each other such that lanyard 10 (and connector 100) are field-replaceable, also as described later herein.

Rigid fastener 200 can take any suitable form. By definition, a rigid fastener is one in which at least the structural (e.g. load-bearing) components of the fastener are rigid (e.g., made of a metal such as steel or aluminum). In many permissible embodiments one such rigid component will be hingedly connected to another rigid component of the fastener as discussed below. Some such rigid fasteners may comprise one or more ancillary, non-structural components that are not rigid (e.g. one or more of tags, labels, or the like). By definition, a rigid fastener 200 is configured to be fastened to, and unfastened from, any desired entity. In many embodiments, rigid fastener 200 will be a hook that comprises a hook portion 203 that at least partially defines an aperture 204 that is sized and configured to receive an entity therethrough so that hook 200 can be engaged with (e.g. attached to) the entity. In some embodiments, such a hook may be a gated hook that comprises a gate 205 that is hingedly connected e.g. to hook portion 203 (or to any convenient component of hook 200) as shown in exemplary embodiment in FIG. 1. In some embodiments, such a gate may be biased toward the closed position so that the gate is self-locking. In some embodiments such a hook may comprise a lock that holds a gate in the closed position and/or may comprise one or more actuators (e.g. handles, triggers or switches) that allow the gate to be unlocked and moved out of the closed position at a desired time.

Rigid fastener 200 may be of any suitable design, e.g. chosen from a wide variety of hooks (e.g. those available under the trade designation SAFLOK), e.g. of the types disclosed in the 3M DBI-SALA® Fall Protection Full Line Catalogue (2017). In some embodiments, rigid fastener 200 may be a snap hook of the general type disclosed in U.S. Pat. No. 9,707,419, which is incorporated by reference herein in its entirety. In some embodiments, a rigid fastener 200 may be of the general type described in U.S. Provisional Patent Application 62/628,720, which is incorporated by reference in its entirety herein. In some embodiments such a rigid fastener may, for example, comprise one or more sensors (e.g. an electromagnetic sensor, an optoelectronic sensor, or the like) that can sense whether or not an item is present within aperture 204 and/or one or more sensors that can sense whether or not gate 205 is in an open position or a closed position. In summary, in various embodiments a rigid fastener 200 may take the form of e.g. any hook as configured for any desired use; exemplary types of hooks include e.g. those known as standard hooks, rebar hooks, tower hooks, and so on.

In some embodiments a rigid fastener 200 may be self-engaging, meaning that fastener 200 may be engaged to an entity merely by appropriately pressing a hingedly openable gate 205 of the fastener against the entity. In other embodiments actuation of one or more handles, switches or the like may be required in order to open gate 205. In some embodiments a fastener 200 may be self-locking e.g. if a hinged gate thereof is biased (e.g. spring-loaded) to snap shut after allowing passage of an entity through the gap created when the gate is opened. In many embodiments, a fastener 200 may be configured to allow one-handed operation. Regardless of the particular design, any such rigid fastener 200 will be load-bearing in the general manner described for lanyard 10 and soft, endless connector 100 later herein.

Regardless of the particular design, any such rigid fastener 200 will comprise a captive eye 201 by which the fastener can be connected to a lanyard 10. Those of ordinary skill in the art of rigid fastener design will appreciate that a captive eye is an opening in the fastener that allows one or more items (e.g. connectors or portions thereof) to pass thereinto and that is bounded by one or more rigid members 202. By definition, a captive eye of a rigid fastener is bounded by members that are rigid and that are not movable relative to each other (in other words, a captive eye cannot be gated so that it is openable). Thus, the only way that an item can be connected to a captive eye is by manipulation of the item itself (e.g. passing the item through the captive eye and then arranging the item in a particular way that connects the item to the captive eye, e.g. to a rigid member 202 that at least partially defines the captive eye).

In some embodiments, a rigid fastener (e.g. a hook) 200 as disclosed herein may comprise a longer service life than a lanyard 10 with which the fastener is used. That is, a rigid fastener may be used with a lanyard and may later be used with a replacement lanyard that is substituted for the original lanyard. Such an arrangement can be particularly advantageous if the rigid fastener is, for example, a “smart hook” that includes sensors, electronics, or the like.

Lanyard 10 can take the form of any suitably elongate, flexible member that is configured to meet all requirements of a particular fall-protection use. In some embodiments, lanyard 10 can take the form of a flexible webbing or flexible rope, comprised of a fibrous material, e.g. woven or otherwise suitably intertangled set of fibers. The term webbing is used herein for convenience in describing fibrous items with relatively high width/thickness ratio (i.e. a ratio over 1.5), with the term rope being used for convenience in describing fibrous items that are more cylindrical in cross-section. In some embodiments, such a webbing may comprise a width/thickness aspect ratio of at least 2.0:1, 2.5:1, 3.0:1, 3.5:1, or 4.0:1. Such a webbing may thus possess a long axis, a width axis, and a thickness axis, and may exhibit first and second, oppositely-facing major faces and first and second, oppositely facing minor edges. In some embodiments, webbing may be particularly convenient for use as a lanyard since it may enhance the ease with which major faces of sections of the lanyard can be brought into contact with other (or with a major face of some other webbing) and attached to each other (e.g. by stitching) for various purposes as will be evident herein.

Regardless of the particular geometric design, any such lanyard may be comprised of any fibrous material(s), arranged in any configuration, that is suitably chosen to meet the requirements of a particular fall-protection use. (The term fall-protection as used herein applies specifically to fall-protection of humans (e.g. workers at elevated heights) and does not encompass any application involving the handling of non-human objects, cargo, tools, or the like.) Regardless of the particular fall-protection use, a lanyard 10 is load-bearing by definition. By load-bearing is meant that in ordinary use, lanyard 10 is capable of bearing a load imparted by a human user (e.g. weighing at least 150 pounds) of lanyard 10. It will be appreciated that in some circumstances (e.g., when used to arrest a fall), lanyard 10 may at least momentarily bear a dynamic load that is somewhat greater than the actual weight of the human user. In various embodiments, lanyard 10 may exhibit a minimum breaking strength of at least about 310, 900, 1800, 3600, 5000, 5400, 7000, or 9000 lb_{f}. Beyond this, it will be understood that lanyard 10 (and all components of a fall-protection assembly 1 with which lanyard 10 is used) will meet all applicable performance standards and criteria, and regulatory requirements, that are required for any particular fall-protection use.

In general, a lanyard 10 may take the form of any elongate, flexible entity comprised of a fibrous material; e.g. comprised of woven, twisted, braided, or otherwise intertangled organic polymeric strands, plies, fibers, filaments, threads, or the like. Such a fibrous material may be comprised of any suitable organic polymer or polymers, and in some embodiments may be comprised of aramids (e.g. as available under the trade designations TECHNORA, KEVLAR or NOMEX), nylons, polyesters (e.g. fibers available under the trade designation VECTRAN) and so on. In particular embodiments such a fibrous material may be comprised of fibers of ultra-high molecular weight polyethylene. Suitable materials of this general type may include, for example, the materials available from DSM (Heerlen, Netherlands) under the trade designation DYNEEMA.

Second end 12 of lanyard 10 may comprise at least one fall-protection item 300 as shown in exemplary embodiment in FIG. 1. Second end 12 is at least generally opposite first, forward end 11 of lanyard 10, and will be referred to herein as a rearward end of lanyard 10. The at least one fall-protection item 300 is not limited to any particular number or type of fall-protection items, entities, apparatus, or systems. In some embodiments, such an item may comprise a rigid connector 301 (e.g., a hook, carabiner, D-ring or the like) that allows second end 12 of lanyard 10 to be attached to, for example, to a fall-protection harness worn by a human user. In some embodiments, the at least one fall-protection item 300 may comprise a shock absorber 302, by which is meant any entity that serves to bring a human user's fall to a more gentle halt. A shock absorber 302 may be of any suitable type. For example, some such shock absorbers rely on a section of webbing that is folded into an “accordionized” configuration and is then held (e.g. stitched) in that configuration in such manner that the section will “unzip” upon being subjected to sufficient force. It is emphasized however that any shock absorber, of any suitable type, may be used.

As noted above, disclosed herein is an arrangement in which a soft, endless connector 100 is used to connect a first end 11 of a lanyard 10 to a rigid fastener 200 (e.g., a gated hook). By “soft” is meant that a section of connector 100 that makes up at least 70% of the elongate (circumferential) length of connector 100 is conformable, deformable, and pliable, so that this at least this section of connector 100 can be easily manipulated by hand by a person, without necessitating the use of tools or the like. The stipulation that only 70% of the elongate length of the connector need satisfy this requirement is to allow that in some embodiments a soft connector 100 may comprise, for example, an at least semi-rigid shroud, sleeve, compression fitting, or the like, that extends over e.g. 20% of the elongate length of the strip. In many embodiments the “soft” section of connector 100 may make up at least 80, 90, 95, or essentially 100% of the elongate length of connector 100. (In embodiments in which connector 100 takes the form of an elongate strip of material that is formed into a permanent loop (as described below in detail), this elongate length is with reference to the total circumferential length of the strip.)

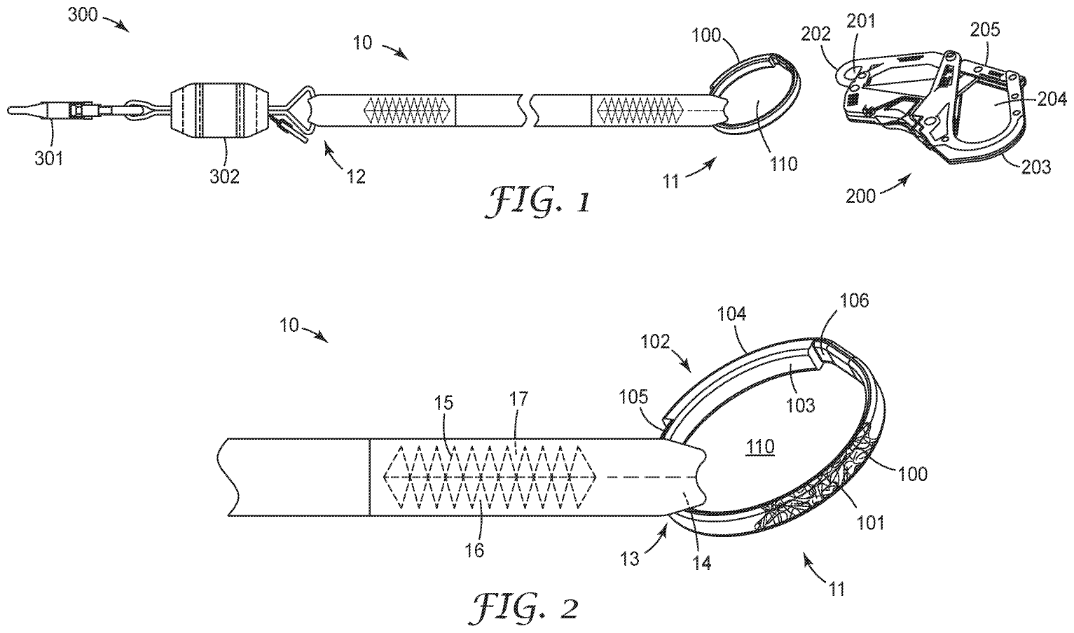

In many embodiments such a soft connector will be formed from an elongate strip of fibrous material, e.g. a webbing or rope of organic polymer fibers. Many such strips will be easily recognizable by ordinary artisans as meeting the above definition of “soft”, upon even casual inspection. Thus for example a connector 100 can be easily judged as meeting this definition of soft, e.g. if the connector can be easily folded over on itself by hand at any point along at least 70% of the elongate length of the connector. With regard to the particular design of connector 100 shown in FIG. 1 and shown in greater detail in FIG. 2, it will be evident that a “double-thickness” junction 102 in which two sections of an elongate strip are joined to each other in overlapping relation in order to form an endless loop, may be somewhat stiffer than the remaining “single-thickness” length of the connector. However, such a connector will still fit the definition of a soft connector as used herein.

In similar manner to lanyard 10, a soft connector 100 may take the form of any elongate, flexible fibrous material comprised of e.g. woven, twisted, braided, or otherwise intertangled polymeric strands, plies, fibers, filaments, threads, or the like. Soft connector 100 may be made of, for example, any of the above-mentioned organic polymeric materials, and may meet any of the criteria (e.g. breaking strength) that are presented above with regard to lanyard 10. While connector 100 is flexible, in some embodiments it will not exhibit any appreciable elasticity under conditions of ordinary use. In various embodiments, connector 100 will be non-elastic so as to exhibit a Young's modulus of at least 1, 2, 4, 8, or 16 GPa. If desired, in some embodiments at least a desired portion of the elongate length of connector 100 may be fitted with a flexible sleeve that, for example, may provide enhanced handleability, abrasion resistance, etc. Such a sleeve, if present, will be sufficiently flexible to allow connector 100 to be conformable and manually manipulable as described above.

Whatever the particular form and composition, a soft connector 100 as disclosed herein will be load-bearing in like manner as described above with regard to lanyard 10. Those of ordinary skill will appreciate that a “soft” connector as disclosed herein will be distinguished from commonly used rigid (“hard”) connectors such as e.g. carabiners and D-rings. That is, the term “soft” connector as used, herein, specifically excludes any such connector as a D-ring, carabiner, or the like. Furthermore, a soft connector as disclosed herein will not rely on any kind of rigid connecting buckle, latch or the like. Thus for example, a rigidly-locking buckle that is mounted on a strip of flexible webbing, would not quality as being a soft connector as defined herein.

Connector 100 is an “endless” connector. By this is meant that connector 100 is in the shape of a permanent loop that has neither beginning nor end when the elongate (circumferential) length of the connector is followed, as evident from the exemplary illustrations of FIGS. 1 and 2. In many convenient embodiments, such an endless-loop connector may be formed by taking an elongate strip of material (e.g. webbing) and putting first and second sections 103 and 104 into overlapping relation with each other and then non-separably joining the sections to each other to form an overlapping junction 102 such that the elongate strip is formed into a permanent, endless loop e.g. as shown in FIG. 2. In embodiments in which the elongate strip is a webbing, the first and second sections 103 and 104 can be positioned with a first major surface 105 of one section and a second major surface 106 of the other section in face-to-face relation, and the two sections can then be non-separably joined together e.g. by stitching. However, any desired method of non-separable joining (e.g. by use of one or more compression fittings) can be used if desired. In some embodiments, the first and second sections 103 and 104 that are joined together to form the endless, permanent loop, are oppositely-extending terminal sections of the elongate strip of fibrous material as in the exemplary design depicted in FIG. 2.

Connector 100 is non-removably connected to first end 11 of lanyard 10. By “non-removably” connected is meant that connector 100 and lanyard 10 are configured so that in ordinary use and maintenance of lanyard 10 (and of fall-protection assembly 1 as a whole), connector 100 is not removable from lanyard 10 without damaging or destroying one or both of connector 100 and lanyard 10. In some convenient embodiments, connector 100 may be non-removably connected to first end 11 of lanyard 10 by providing a terminal loop 13 at first end 11 of lanyard 10, loop 13 defining an opening 14 through which a portion of connector 100 passes as shown in exemplary embodiment in FIG. 2. In some particularly convenient embodiments, such a terminal loop 13 and opening 14 may be provided by turning back a terminal section 16 of lanyard 10 onto a penultimate section 17 of lanyard 10 and then non-separably joining the two sections to each other, e.g. by stitching 15 as in the exemplary design of FIG. 2. (In this and in all other instances herein, the term “non-separable” means that items are joined so that they are not separable from each other in ordinary use of the items and are not separable without damaging or destroying either or both items.)

In some embodiments, a soft, endless connector 100 that is in the form of a permanent loop that is non-removably connected to a first end of a lanyard, may be a “floating” loop. By a “floating” loop is meant that any portion of connector 100 that may be in contact with any portion of lanyard 10 at any point in time, is not attached to lanyard 10 at the point of contact. In other words, a connector 100 in the form of a floating loop as in FIG. 2, can be rotated along its circumferential direction relative to lanyard 10. Thus, for example, the overlapping junction 102 of connector 100 does not have to remain in the specific location shown in FIG. 2. Rather, connector 100 is rotatable relative to lanyard 10 to a position in which, for example, a portion of junction 102 is located within opening 14 of lanyard 10.

In other words, a “floating” loop is movable (e.g., is rotatable along the circumferential direction of the loop) relative to the lanyard to which it is connected, in analogous manner to how some keyrings (i.e., circular, “split-ring” keyrings) are able to be rotatably moved relative to keys to which they are connected. Thus in summary, a connector 100 that is in the form of a floating loop is non-removably connected to lanyard 10 (e.g. by way of passing through opening 14 of lanyard 10) but is not physically joined to lanyard 10 at any point of contact. In some particular embodiments, a connector 100 in the form of a webbing can take the form of a Mobius strip, e.g. by including a half-twist in an elongate strip before sections of the strip are joined together to form the permanent loop.

Soft, endless connector 100 can thus be provided in the form of a permanent loop that defines an opening 110 as evident in FIG. 2. Connector 100 is non-removably connected to a first end 11 of a lanyard 10 as noted above, and can be removably connected to a rigid fastener 200 (e.g. a hook) to removably connect the lanyard and the rigid fastener to each other. By removably connected is meant that connector 100 is connected to fastener 200 in such manner that in ordinary use (e.g., maintenance and servicing) of lanyard 10 (and of fall-protection assembly 1 as a whole), connector 100 can be disconnected from fastener 200 manually without the use of tools, and without damaging or destroying either of connector 100 and fastener 200. By definition, a connector 100 that is removably connectable to a fastener 200 can be re-connected to, and disconnected from, a fastener 200 any number of times as desired.

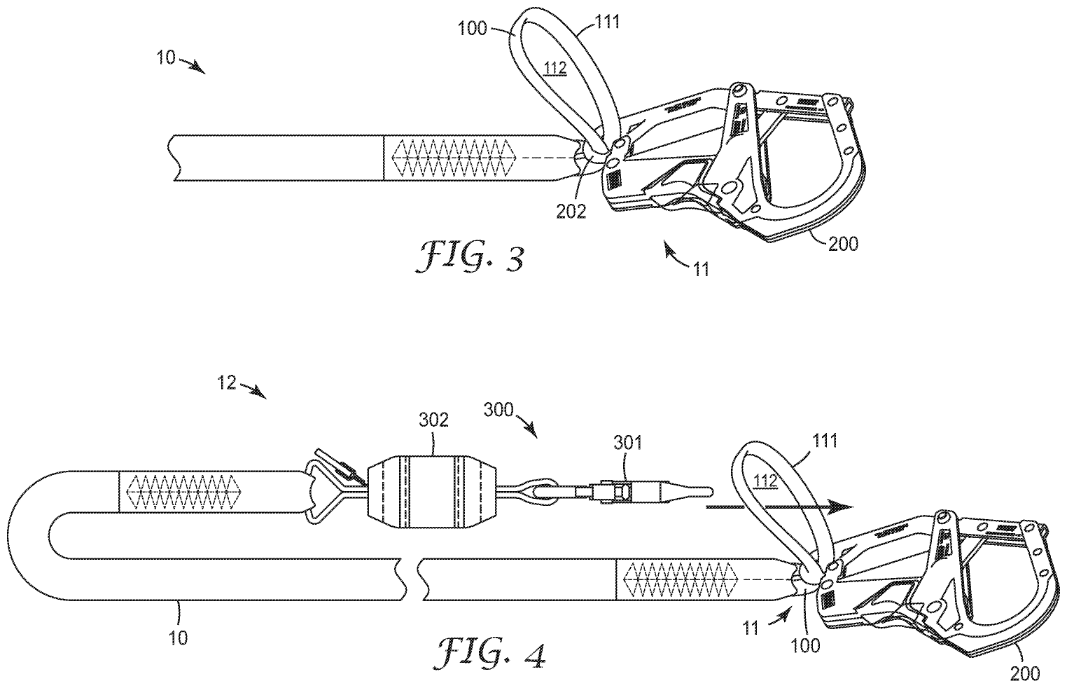

Such a removable connection can be achieved by hitching connector 100 to a rigid member 202 of a rigid fastener 200 as follows. At least a portion 111 of connector 100 can be passed through a captive eye 201 of rigid fastener 200, in the general manner shown in FIG. 3. Portion 111 that is passed through captive eye 201 will define an accessible opening 112. As indicated in FIG. 4, lanyard 10 can be passed through accessible opening 112 e.g. as indicated by the arrow in FIG. 4. In the exemplary arrangement of FIG. 4, second end 12 (and items connected thereto) of lanyard 10 is the leader in being passed through accessible opening 112. Successive portions of lanyard 10 follow until (with the majority of the elongate length of lanyard 10 having been passed through opening 112) until any further motion is stopped by reaching first end 11 of lanyard 10. However, in some embodiments a section of lanyard 10 that is distal to second end 12 may be the leader in being passed through opening 112; in such an operation second end 12 (and items attached thereto) may then follow so as to be the trailing end.

The majority of the elongate length of lanyard 10 (e.g., up to a point proximate first end 11 of lanyard 10) is passed through opening 112 in this general manner. This results in connector 100 being hitched to rigid fastener 200 (specifically, to a rigid member 202 that defines at least a portion of a captive eye 201 of fastener 200). By “hitch” is meant an arrangement in which connector 100 is removably connected to fastener 200, without necessitating any terminal ends of connector 100 (of which connector 100, being endless, has none) being tied in any kind of knot. Rather, connector 100 remains in the form of an endless loop which has merely been formed into a hitch 150 that captures rigid member 202 of fastener 200.

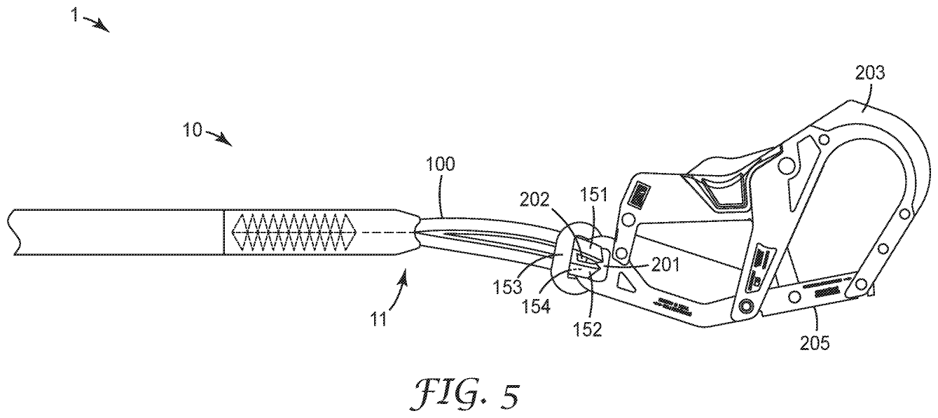

Such a hitch 150 (e.g. when snugged relatively tight) will exhibit a general form shown in FIG. 5. That is, two segments 151 and 152 of connector 100 will reside in generally parallel relation at a location at which they overlie rigid member 202 of fastener 200. As these segments pass into captive eye 201, they diverge in generally opposite directions and pass behind, and wrap around, different portions of rigid member 202. After wrapping around rigid member 202 in this manner, they meet to form a crossing section 153 that overlies the portions of the segments that overlie rigid member 202. An endless-loop connector 100 as arranged in this manner will define a passage 154 through which a portion of rigid member 202 of fastener 200 passes and within which passage this portion of rigid member 202 is trapped, thus achieving the connection of connector 100 to rigid member 202 and thus to fastener 200.

It will be understood that the depiction of hitch 150 in FIG. 5 (and the associated description above) in which connector 100 is snugged relatively tight, is provided to facilitate describing how hitch 150 can be identified. At any given time during actual use of lanyard 10 and connector 100, connector 100 may not necessarily be snugged tight to the extent shown in FIG. 5.

In some embodiments hitch 150 is a rearwardly engaging/disengaging hitch. By this is meant that, as illustrated in FIG. 4, hitch 150 is formed by passing second, rearward end 12 of lanyard 10 (and any and all items that are attached to second end 12 of lanyard 10; or, in general, are attached to lanyard 10 at any location along its elongate length) through an accessible opening 112 of connector 100 in the manner described above. Thus in embodiments of the type depicted in FIG. 4, rigid connector 301 and shock-absorber 302 must be able to pass through opening 112. Such arrangements require that any soft, endless connector 100, and any fall-protection item 300, must be configured so that the fall-protection item or items e.g. at the second end 12 of lanyard 10, must be able to pass through an accessible opening 112 defined by connector 100. In other words, the size of the permanent loop formed by connector 100, and the extent to which connector 100 is able to be inserted through a captive eye of a rigid fastener to form an accessible opening 112, must be arranged so that the resulting accessible opening 112 is sufficiently large to allow a desired fall-protection item or items to pass therethrough. In various embodiments, connector 100, lanyard 10, and rigid fastener 200 may be configured so that an accessible opening 112 that is provided by protruding portion 111 of connector 100 in the manner described above, defines an accessible area that is from at least 102, 110, or 115%, to at most 150, 140, 130, or 120%, of the largest cross-sectional area of a fall-protection item at the second end of lanyard 10. This largest cross-sectional area of a fall-protection item is any cross-sectional area of the fall-protection item that, if greater than the accessible area of opening 112 established by connector 100, will prevent the fall-protection item from being passed through opening 112. In most instances this largest cross-sectional area will be occur when viewing the fall-protection item along a direction aligned with the longest axis of the fall-protection item, e.g. an axis that is generally aligned with the elongate axis of lanyard 10.

As noted above, in some embodiments a lanyard 10 can be a component of a fall-protection assembly of the general type shown in FIGS. 1-5. Such assemblies are sometimes referred to as single-leg lanyards. In many uses of such an assembly, rigid connector 301 is attached to a fall-protection harness worn by a human user; the user then attaches rigid fastener 200 to any desired anchorage point, beam or member, or the like.

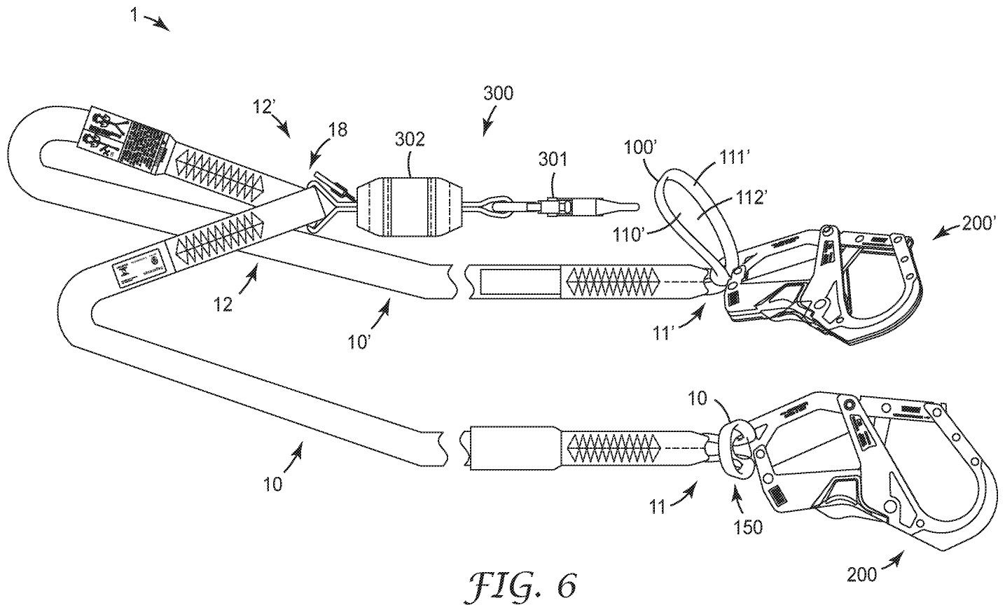

In some embodiments a lanyard 10 can be a component of a twin-leg fall-protection assembly 1 of the general type shown in FIG. 6. Such an assembly may comprise a first lanyard 10 with a first end 11 that is removably connected to a first rigid fastener (e.g. a hook) 200 by a first soft, endless connector 100. Such an assembly may further comprise a second lanyard 10′ with a first end 11′ that is removably connected to a second rigid fastener (e.g. a hook) 200′ by a second soft, endless connector 100′. In some embodiments all such second items may be equivalent (e.g. similar to or identical to) the first items, as in the exemplary arrangement of FIG. 6. In such an assembly, second end 12 of first lanyard 10 and second end 12′ of second lanyard 10′ may meet at a junction 18. At or near junction 18 may be provided one or more fall-protection items, e.g. a shock absorber 302 and/or a rigid connector 301. In many uses of such an assembly, rigid connector 301 is attached to a fall-protection harness worn by a human user. The user may attach first rigid fastener 200 to any desired anchorage point, beam or member. The user may then attach second rigid fastener 200′ to some other anchorage point. After this, the user can then detach first rigid fastener 200 and move it to some other anchorage point. These steps may be performed successively e.g. in the act of climbing or otherwise moving on a structure.

The assembly of FIG. 6 is shown with first connector 100 of first end 11 of first lanyard 10 already having been removably connected to a first rigid fastener 200 (the thus-formed first hitch 150 is shown in a partially-snugged condition). Second connector 100′ is shown partway through the process of being connected to a second rigid fastener 200′. That is, a portion 111′ of second connector 100′ has been passed through a captive eye of second fastener 200′ to establish an accessible opening 112′ through which various items are passed to perform the connecting of second connector 100′ to second rigid fastener 200′.

It will be appreciated that such an arrangement requires that, in connecting first connector 100 to first rigid fastener 200, not only second end 12′ of first lanyard 10 must be passed through the accessible opening of first connector 100. Rather, second lanyard 10′ (along with items 301 and 302) must also be passed through that accessible opening. Furthermore, once first connector 100 is attached to first rigid fastener 200, the connecting of second connector 100′ to second rigid fastener 200′ will require that second end 12′ of second lanyard, and, the entirety of first lanyard 10 as well as first rigid fastener 200, must be able to pass through second accessible opening 112′ established by second connector 100′. This is readily apparent from inspection of FIG. 6. Thus in such embodiments, the various connectors (e.g. 100 and 100′) must be configured (e.g. sized) in view of the sizes of the respective rigid fasteners (e.g. 200 and 200′) that are intended to pass through the accessible openings established by the respective connectors. It will be understood that in arrangements of the general type shown in FIG. 6, first connector 100 and second connector 100′ form rearwardly engaging/disengaging hitches when connected to their respective rigid fasteners.

Once a rearwardly engaging-disengaging hitch 150 is established that connects a soft, endless connector 100 to a rigid fastener 200, the connection will remain in place until the above-described process is reversed. Such a process involves loosening the connector so that an accessible opening is re-established and passing the second (rearward) end of the lanyard, and all fall-protection items connected to the second end of the lanyard, back through this accessible opening. It is emphasized that the concept of a hitch (whether rearwardly engaging/disengaging as described above, or forwardly engaging/disengaging as described below) requires that the connector is not “tied” to the rigid fastener in the manner of a knot that can be untied by manipulating terminal ends of the connector itself. In particular, a rearwardly engaging/disengaging hitch requires that the only way that the connector can be disconnected from the rigid fastener is by passing the second (rearward) end of the lanyard, the remaining portion of the lanyard, and any fall-protection items attached to the lanyard, back through the above-described accessible loop.

By definition, a rearwardly engaging/disengaging connector 100 (e.g., connector 100 as shown in FIG. 3) that forms a rearwardly engaging/disengaging hitch 150, is configured (e.g., sized) so that the accessible opening 112 that is formed when at least a portion 111 of connector 100 is passed through a captive eye 201 of a rigid fastener 200, is too small to allow the rigid fastener itself to pass through accessible opening 112. (Alternatively phrased, opening 112 is too small to allow portion 111 of connector 100 to be passed over rigid fastener 200).

In other embodiments, a soft, endless connector 100 can be a forwardly engaging/disengaging connector that forms a hitch 150 that is a forwardly engaging/disengaging hitch. By definition, a forwardly engaging/disengaging connector 100 is configured (e.g. sized) to provide an accessible opening 112 that rigid fastener 200 is able to pass through. In such embodiments, connector 100 can be hitched to rigid fastener 200 by pushing a portion 111 of connector 100 through captive eye 201 to establish an accessible opening 112, after which portion 111 of connector 100 is passed over a first side of rigid fastener 200 (so that rigid fastener 200 passes through accessible opening 112) so that portion 111 is positioned on the second, opposite side of rigid fastener 200. Connector 100 can then be snugged in similar manner as described above, to arrive at a hitch 150 that is substantially similar to the previously-described hitch, but that was arrived at by a different mode of engaging.

This may be illustrated by reference to a forwardly engaging/disengaging connector viewed from a similar viewpoint as in the above-discussed FIG. 3. A portion 111 of a suitable forwardly engaging/disengaging connector 100 would be passed upward through a captive eye from the “bottom” side of a rigid fastener. Portion 111 would then be moved to the right across the “top” side of the rigid fastener. Portion 111 would be spread and passed over the forward end of the rigid fastener so that portion 111 ends up on the “bottom” side of the rigid fastener (with the rigid fastener having passed through the accessible opening 112 of portion 111 of the connector in this process). The connector could then be snugged to form a hitch 150. These operations can be reversed to undo hitch 150 to disconnect connector 100 (and lanyard 10) from rigid fastener 200.

Two general types of embodiments have been described above. The first is a rearwardly engaging/disengaging connector in which the connector is configured (e.g. sized) so that a second (rearward) end of the lanyard and one or more fall-protection items attached thereto, is able to pass through an accessible opening 112 established by the connector, but with the connector being configured so that a rigid fastener at the first (forward) end of the lanyard is not able to pass through the accessible opening 112. The second is a forwardly engaging/disengaging connector in which the connector is configured so that a rigid fastener at the first (forward) end of the lanyard is able to pass through an accessible opening 112 established by the connector, but with the connector being configured so that the second (rearward) end of the lanyard and one or more fall-protection items attached thereto, is not able to pass through the accessible opening 112.

In a third type of embodiment a connector may be a dual engaging/disengaging connector. By definition such a connector is configured to form an accessible opening 112 that the second (rearward) end of the lanyard with one or more fall-protection items attached thereto is able to pass through; and, that the rigid fastener at the first (forward) end of the lanyard is also able to pass through. Such a connector may be engaged and disengaged (connected and disconnected) by either of the above-described methods.

Regardless of whether any such connector 100 is configured to be forwardly, rearwardly, or dual engaging/disengaging as described above, any actual use of the connector (and lanyard, and all apparatus and systems associated therewith) will be in accordance with all applicable operating instructions, guidelines, standards, requirements, and so on.

The arrangements disclosed herein allow a lanyard to be field-replaceable. By field-replaceable is meant that a lanyard 10 and a soft, endless connector 100 can be disconnected from a rigid fastener 200, and a new lanyard and soft, endless connector can be removably connected to the rigid fastener, by an end user (e.g. a worker, a safety manager, or other designated person) rather than having to be sent back to the manufacturer (or to a service facility) for this to be performed. Furthermore, by field-replaceable is specifically meant that the disconnecting of the existing lanyard, and the connecting of the replacement lanyard, can both be performed by manually (by hand), by an end user without the use of any special tools, devices, fixtures or holders, or the like. In particular, these operations can be performed without performing any special procedures such as sewing, stitching, welding, brazing, crimping, and so on. The arrangements disclosed herein will thus be contrasted with conventional lanyards that are connected to a rigid fastener by way of, for example, a terminal section of the lanyard being passed through a captive eye of the fastener and then stitched to a penultimate section of the lanyard so that the lanyard and fastener can only be disconnected from each other by de-stitching or by severing the lanyard.

It will thus be appreciated that a connector as disclosed herein advantageously allows a lanyard to be quickly and easily field-replaced, without any special tools or operations being required. Furthermore, in comparison to e.g. the use of a rigid connector such as a D-ring, carabiner or the like, a soft connector as disclosed herein can allow enhanced freedom of movement of the lanyard relative to the rigid fastener, e.g. without restricting rotation in the manner sometimes encountered when using a rigid connector such as a D-ring.

In some embodiments it may be useful for lanyard 10 and/or connector 100 to comprise at least one date-indicating indicia indicative of e.g. the manufacturing date. Such an indicia will be easily visible and can allow a user or other designated person to quickly visually interrogate the lanyard and/or connector to obtain an indication of the age of the lanyard. In some embodiments such an indicia may take the form of a label that is attached to lanyard 10 or to connector 100. However, the term indicia is used broadly herein, and encompasses labels, printed indicia or the like, as well as indicia that are integral to the lanyard or connector. An integral indicia might take the form of, for example, a color indicator. One such approach might involve manufacturing lanyards in different colors (e.g. along some portion of their length or along the entirety of their length, or as a stripe along at least a portion of the lanyard) at different times (e.g. in different years). In some embodiments a colored indicia may be provided by colored filaments that are incorporated (e.g. woven) into the lanyard or connector in the shape of the desired indicia (e.g., a manufacturing year). By any such approach, a user or other designated person may be made aware that a lanyard was manufactured in a particular year.

It is emphasized that any such providing of a date-indicating indicia to allow visual interrogation e.g. in order to quickly ascertain an estimate of the age of a lanyard, is an optional feature that may be provided for the user's convenience. Any such feature will be in addition to, and will not take the place of, whatever visual inspection and examination of lanyards, connectors, and associated fall-protection items as are customarily performed and as may be required by various instructions, guidelines, standards and requirements.

The above-described embodiments can be modified as desired. For example, rather than a “floating” loop as described above, in some embodiments a soft, endless connector 100 can be attached (e.g. stitched) to a first end 11 of a lanyard 10 so that it is a non-floating loop. In some embodiments of this type, a soft, endless connector may comprise an elongate strip of material (e.g. webbing) that is non-removably connected to the first end of a lanyard by way of first and second terminal sections of the elongate strip of material being non-separably joined to first and second major faces of a terminal section of the lanyard. Such a soft, endless connector will thus take the form of a non-floating loop projecting from the first end of the lanyard. Such embodiments represent a special case of an endless loop, in which a small portion of the endless loop into which the connector is formed, is provided by a portion of the lanyard itself.

In still another variation, a soft, endless connector may be directly formed in the lanyard itself. In such embodiments, the soft, endless connector may take the form of a non-floating, endless loop that is integrally formed in the lanyard at the first end of the lanyard. Such a loop may be formed e.g. by turning a terminal section of the lanyard back onto a penultimate section of the lanyard and non-separably joining the terminal section to the penultimate section to provide an endless terminal loop defining a permanent opening of the desired size. Such an embodiment represents a special case of an endless loop, in which the entirety of the endless loop is provided by portions of the lanyard itself.

Regardless of the specific design, any such soft, endless connector may be configured to, for example, allow at least one fall-protection item that is connected to a second, opposing end of the lanyard to pass through an accessible opening of the soft, endless connector, which accessible opening is established by a portion of the soft-endless connector that is inserted through a captive eye of a rigid fastener to which the connector is to be removably connected.

Still further variations are possible. For example, in some embodiments first and second soft, endless fasteners may be provided at the same (first) end of a lanyard. The first and second fasteners may be lightly stitched or otherwise attached together so that they can be handled and manipulated (e.g. formed into a hitch) as a single unit, but so that they function largely independently once formed into a hitch. Such fasteners may e.g. take the form of webbings that exhibit similar width and thickness but that differ slightly from each other in overall size (elongate length) to enhance their ability to be attached to each other so as to form an easily handleable unit.

In some embodiments, first end 11 of lanyard 10 (in particular, a terminal loop 13 formed in the first end thereof) can be sized with regard to a captive eye 201 to which the first end 11 is to be connected via a soft, endless connector 100. In some embodiments, first end 11 of lanyard may be sufficiently small in comparison to captive eye 201 that first end 11 can pass into and through captive eye 201. In such embodiments, the entirety of opening 110 that is exhibited by a soft, endless connector 100, may be available to form accessible opening 112. In other embodiments, first end 11 of lanyard 10 may be sufficiently large in comparison to captive eye 201 that first end 11 cannot pass into captive eye 201. In such embodiments, only a portion of opening 110 of soft, endless connector 100 may be available to form accessible opening 112. In such embodiments, the elongate (circumferential) length of soft, endless connector 100 should be chosen to ensure that a sufficiently large accessible opening 112 can be formed. In various embodiments, a soft, endless connector 100 may define an opening 110 that is at least 50, 100, or 200 square cm.

Whatever the specific design, lanyard 10 and soft, endless connector 100, are provided as a combined unit. That is, connector 100 is non-removably connected to lanyard 10 and thus neither of these components can be replaced without replacing the other. In various embodiments, a lanyard 10 (and/or an assembly 1) comprising a soft, endless connector 100 as described herein, will meet the requirements of any or all of ANSI ASSE Z359.12, CSA 259.12, and BS EN 362:2004.

It will be appreciated that the specific embodiments and arrangements disclosed herein all fall within the general precept of a fall-protection lanyard to which a soft connector is non-removably connected, with the soft connector being removably connected to a rigid fastener such as e.g. a hook, so that the lanyard is removably connected to the rigid fastener. Such a lanyard may be part of a fall-protection assembly in which the lanyard comprises one or more fall-protection items, apparatus or systems, of any suitable kind. In some embodiments such a lanyard might be of the type commonly referred to as a positioning lanyard or an energy-absorbing lanyard. Various lanyards with which a soft, endless connector as disclosed herein may be used include e.g. products available from 3M Fall Protection, Red Wing, Minn., under the trade designations EZ-STOP, EZ-STOP III, SHOCKWAVE 2, FORCE2, WRAPBAX 2, RETRAX, CYNCH-LOK, PRO STRETCH, PRO-STOP, and PRO-PACK.

In various embodiments, a lanyard as disclosed herein may be used in combination with, or as a part of, any desired fall-protection system, including but not limited to a self-retracting lifeline, a horizontal lifeline or retractable horizontal lifeline, a positioning lanyard, a shock-absorbing lanyard, a rope adjuster or rope grab, a load arrester, a vertical safety system (such as e.g. a flexible cable, rigid rail, climb assist, or fixed ladder safety system), a confined-space rescue system or hoist system, and so on. Any such system may make use of one or more of any ancillary items such as e.g. centrifugal brakes, tear strips, harnesses, belts, straps, paddings, tool holsters or pouches, impact indicators, carabiners, D-rings, anchorage connectors, and the like. A wide variety of lanyards, apparatus, systems, components, etc. are described in detail e.g. in the 3M DBI-SALA® Fall Protection Full Line Catalogue (2017). It will be understood that a soft, endless connector as disclosed herein may find use with any of these. Whatever the use, the lanyards, assemblies, etc. disclosed herein will be used in accordance with operating instructions, guidelines, standards and requirements as are applicable to that use.

### List of Exemplary Embodiments

Embodiment 1 is a fall-protection assembly comprising: a load-bearing lanyard comprising a first end with a load-bearing, soft, endless connector non-removably connected thereto; and, a rigid fastener comprising a rigid member that defines at least a portion of a captive eye of the rigid fastener, to which rigid member the soft, endless connector is removably connected so that the soft, endless connector removably connects the rigid fastener to the first end of the lanyard.

Embodiment 2 is the fall-protection assembly of embodiment 1 wherein the rigid fastener is a gated hook.

Embodiment 3 is the assembly of any of embodiments 1-2 wherein the soft, endless connector comprises an elongate strip of fibrous material formed into a permanent loop, and wherein the elongate strip is hitched to the rigid member of the rigid fastener.

Embodiment 4 is the assembly of embodiment 3 wherein the elongate strip of fibrous material is configured so that the permanent loop is a floating loop in which any portion of the elongate strip that is in contact with any portion of the lanyard is not attached to the lanyard at the point of contact between the elongate strip and the lanyard.

Embodiment 5 is the assembly of any of embodiments 3-4 wherein the elongate strip of fibrous material comprises first and second sections that are in overlapping relation with each other and that are non-separably joined to each other to form the permanent loop.

Embodiment 6 is the assembly of embodiment 5 wherein the first and second sections of the elongate strip of fibrous material are oppositely-extending terminal sections of the elongate strip of fibrous material.

Embodiment 7 is the assembly of any of embodiments 3-6 wherein the elongate strip of fibrous material is a fibrous webbing comprising a width-to-thickness aspect ratio of at least 1.5.

Embodiment 8 is the assembly of embodiment 7 wherein the permanent loop is a Mobius strip.

Embodiment 9 is the assembly of any of embodiments 3-8 wherein a terminal section of the first end of the lanyard is turned back onto, and non-separably joined to, a penultimate section of the lanyard to form a permanent terminal opening through which the elongate strip of fibrous material passes so that the soft, endless connector is non-removably connected to the first end of the lanyard.

Embodiment 10 is the assembly of any of embodiments 1-9 wherein a second, opposing end of the lanyard comprises at least one fall-protection item.

Embodiment 11 is the assembly of embodiment 10 wherein the soft, endless connector and the at least one fall-protection item are configured so that at least a portion of the soft, endless connector can be passed through the captive eye of the rigid fastener to establish an accessible opening of the soft, endless connector, and so that the at least one fall-protection item is able to pass through the accessible opening of the soft, endless connector.

Embodiment 12 is the assembly of any of embodiments 10-11 wherein the at least one fall-protection item comprises a rigid connector that is attachable to a fall-protection harness to allow the second, opposing end of the lanyard to be connected to the fall-protection harness.

Embodiment 13 is the assembly of any of embodiments 10-12 wherein the at least one fall-protection item comprises a shock absorber.

Embodiment 14 is the assembly of any of embodiments 10-13 wherein the second, opposing end of the lanyard comprises multiple fall-protection items and wherein all of the fall-protection items are configured so that the fall-protection items are able to successively pass through the accessible opening of the soft, endless connector.

Embodiment 15 is the assembly of embodiment 14 wherein the lanyard is a first lanyard, the rigid fastener is a first rigid fastener, and the soft, endless connector is a first soft, endless connector; and, wherein the second end of the first lanyard is non-removably connected to a second end of a second lanyard and wherein a first end of the second lanyard comprises a second rigid fastener comprising a second rigid member that defines at least a portion of a captive eye of the second rigid fastener, to which second rigid member a second soft, endless connector is removably connected so that the second soft, endless connector removably connects the second rigid fastener to the first end of the second lanyard.

Embodiment 16 is the assembly of any of embodiments 1-3 and 7-15 wherein the soft, endless connector comprises an elongate strip of fibrous material that is non-removably connected to the first end of the lanyard by way of first and second sections of the elongate strip of fibrous material being non-removably joined to first and second major faces of a terminal section of the lanyard so that the soft, endless connector is in the form of a non-floating loop projecting from the first end of the lanyard; and, wherein the soft, endless connector is configured to allow at least one fall-protection item that is connected to a second, opposing end of the lanyard, to pass through an accessible opening of the soft, endless connector, which accessible opening is established by a portion of the non-floating loop that is passed through a captive eye of the rigid fastener.

Embodiment 17 is the assembly of any of embodiments 1-3 and 7-15 wherein the soft, endless connector is a non-floating, terminal loop that is integrally formed in the lanyard at the first end of the lanyard and that comprises a terminal section of the lanyard that is turned back onto, and non-separably joined to, a penultimate section of the lanyard to provide the terminal loop; and wherein the soft, endless connector is configured to allow at least one fall-protection item that is connected to a second, opposing end of the lanyard, to pass through an accessible opening of the soft, endless connector, which accessible opening is established by a portion of the terminal loop that is inserted through a captive eye of the hook.

Embodiment 18 is the assembly of any of embodiments 1-17 wherein the load-bearing, soft, endless connector is a rearwardly engaging/disengaging connector that is configured so that a second, rearward end of the lanyard and one or more fall-protection items attached thereto, is able to pass through an accessible opening established by the connector, and that is further configured so that the rigid fastener at the first end of the lanyard is not able to pass through the accessible opening.

Embodiment 19 is the assembly of any of embodiments 1-10, 12, 13 and 15 wherein the load-bearing, soft, endless connector is a forwardly engaging/disengaging connector that is configured so that the rigid fastener at the first end of the lanyard is able to pass through an accessible opening established by the connector, and that is further configured so that a second, rearward end of the lanyard and one or more fall-protection items attached thereto, is not able to pass through the accessible opening.

Embodiment 20 is the assembly of any of embodiments 1-19 wherein a second, opposing end of the lanyard comprises a second load-bearing, soft, endless connector non-removably connected thereto.

Embodiment 21 is the assembly of any of embodiments 1-20 wherein the rigid fastener is a gated hook that comprises at least one sensor chosen from the group consisting of a sensor that can sense whether an item is present within an aperture defined by the gated hook and a sensor that can sense whether a gate of the gated hook is in an open position or a closed position.

Embodiment 22 is the assembly of any of embodiments 1-21 wherein the lanyard and/or the soft, endless connector bears at least one visible date-indicating indicia.

Embodiment 23 is a method of removably connecting a first end of a load-bearing lanyard to a rigid fastener, the first end of the lanyard comprising a load-bearing, soft, endless connector in the form of a permanent loop that is non-removably connected to the first end of the lanyard, and the method comprising: passing at least a portion of the permanent loop through a captive eye of the rigid fastener so that the portion of the loop that is passed through the captive eye of the rigid fastener establishes an accessible opening of the soft, endless connector; passing a second, opposing end of the lanyard, and at least one fall-protection item that is connected to the second, opposing end of the lanyard, through the accessible opening of the soft, endless connector to hitch the soft, endless connector to a rigid member that defines at least a portion of the captive eye of the rigid fastener so that the soft, endless connector removably connects the rigid fastener to the first end of the lanyard.

Embodiment 24 is the method of embodiment 23 performed using the assembly of any of embodiments 1-18 and 20-22.

It will be apparent to those skilled in the art that the specific exemplary elements, structures, features, details, configurations, etc., that are disclosed herein can be modified and/or combined in numerous embodiments. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). To the extent that there is any conflict or discrepancy between this specification as written and the disclosure in any document that is incorporated by reference herein, this specification as written will control.

What is claimed is:

1. A fall-protection assembly comprising:
a load-bearing lanyard comprising a first end with a load-bearing, soft, endless connector non-removably connected thereto; and,
a rigid fastener comprising a rigid member that defines at least a portion of a captive eye of the rigid fastener, to which rigid member the soft, endless connector is removably connected so that the soft, endless connector removably connects the rigid fastener to the first end of the lanyard.

2. The fall-protection assembly of claim 1 wherein the rigid fastener is a gated hook.

3. The assembly of claim 1 wherein the soft, endless connector comprises an elongate strip of fibrous material formed into a permanent loop, and wherein the elongate strip is hitched to the rigid member of the rigid fastener.

4. The assembly of claim 3 wherein the elongate strip of fibrous material is configured so that the permanent loop is a floating loop in which any portion of the elongate strip that is in contact with any portion of the lanyard is not attached to the lanyard at the point of contact between the elongate strip and the lanyard.

5. The assembly of claim 3 wherein the elongate strip of fibrous material comprises first and second sections that are in overlapping relation with each other and that are non-separably joined to each other to form the permanent loop.

6. The assembly of claim 5 wherein the first and second sections of the elongate strip of fibrous material are oppositely-extending terminal sections of the elongate strip of fibrous material.

7. The assembly of claim 3 wherein the elongate strip of fibrous material is a fibrous webbing comprising a width-to-thickness aspect ratio of at least 1.5.

8. The assembly of claim 7 wherein the permanent loop is a Mobius strip.

9. The assembly of claim 3 wherein a terminal section of the first end of the lanyard is turned back onto, and non-separably joined to, a penultimate section of the lanyard to form a permanent terminal opening through which the elongate strip of fibrous material passes so that the soft, endless connector is non-removably connected to the first end of the lanyard.

10. The assembly of claim 1 wherein a second, opposing end of the lanyard comprises at least one fall-protection item.

11. The assembly of claim 10 wherein the soft, endless connector and the at least one fall-protection item are configured so that at least a portion of the soft, endless connector can be passed through the captive eye of the rigid fastener to establish an accessible opening of the soft, endless connector, and so that the at least one fall-protection item is able to pass through the accessible opening of the soft, endless connector.

12. The assembly of claim 10 wherein the at least one fall-protection item comprises a rigid connector that is attachable to a fall-protection harness to allow the second, opposing end of the lanyard to be connected to the fall-protection harness.

13. The assembly of claim 10 wherein the at least one fall-protection item comprises a shock absorber.

14. The assembly of claim 10 wherein the second, opposing end of the lanyard comprises multiple fall-protection items and wherein all of the fall-protection items are configured so that the fall-protection items are able to successively pass through the accessible opening of the soft, endless connector.

15. The assembly of claim 10 wherein the lanyard is a first lanyard, the rigid fastener is a first rigid fastener, and the soft, endless connector is a first soft, endless connector;
and,
wherein the second end of the first lanyard is non-removably connected to a second end of a second lanyard and wherein a first end of the second lanyard comprises a second rigid fastener comprising a second rigid member that defines at least a portion of a captive eye of the second rigid fastener, to which second rigid member a second soft, endless connector is removably connected so that the second soft, endless connector removably connects the second rigid fastener to the first end of the second lanyard.

16. The assembly of claim 1 wherein the soft, endless connector comprises an elongate strip of fibrous material that is non-removably connected to the first end of the lanyard by way of first and second sections of the elongate strip of fibrous material being non-removably joined to first and second major faces of a terminal section of the lanyard so that the soft, endless connector is in the form of a non-floating loop projecting from the first end of the lanyard; and,
wherein the soft, endless connector is configured to allow at least one fall-protection item that is connected to a second, opposing end of the lanyard, to pass through an accessible opening of the soft, endless connector, which accessible opening is established by a portion of the non-floating loop that is passed through a captive eye of the rigid fastener.

17. The assembly of claim 1 wherein the soft, endless connector is a non-floating, terminal loop that is integrally formed in the lanyard at the first end of the lanyard and that comprises a terminal section of the lanyard that is turned back onto, and non-separably joined to, a penultimate section of the lanyard to provide the terminal loop; and
wherein the soft, endless connector is configured to allow at least one fall-protection item that is connected to a second, opposing end of the lanyard, to pass through an accessible opening of the soft, endless connector, which accessible opening is established by a portion of the terminal loop that is inserted through a captive eye of the hook.

18. The assembly of claim 1 wherein the load-bearing, soft, endless connector is a rearwardly engaging/disengaging connector that is configured so that a second, rearward end of the lanyard and one or more fall-protection items attached thereto, is able to pass through an accessible opening established by the connector, and that is further configured so that the rigid fastener at the first end of the lanyard is not able to pass through the accessible opening.

19. The assembly of claim 1 wherein the load-bearing, soft, endless connector is a forwardly engaging/disengaging connector that is configured so that the rigid fastener at the first end of the lanyard is able to pass through an accessible opening established by the connector, and that is further configured so that a second, rearward end of the lanyard and one or more fall-protection items attached thereto, is not able to pass through the accessible opening.

20. The assembly of claim 1, wherein a second, opposing end of the lanyard comprises a second load-bearing, soft, endless connector non-removably connected thereto.

21. The assembly of claim 1, wherein the rigid fastener is a gated hook that comprises at least one sensor chosen from the group consisting of a sensor that can sense whether an item is present within an aperture defined by the gated hook and a sensor that can sense whether a gate of the gated hook is in an open position or a closed position.

22. The assembly of claim 1 wherein the lanyard and/or the soft, endless connector bears at least one visible date-indicating indicia.

23. A method of removably connecting a first end of a load-bearing lanyard to a rigid fastener, the first end of the lanyard comprising a load-bearing, soft, endless connector in the form of a permanent loop that is non-removably connected to the first end of the lanyard, and the method comprising:
passing at least a portion of the permanent loop through a captive eye of the rigid fastener so that the portion of the loop that is passed through the captive eye of the rigid fastener establishes an accessible opening of the soft, endless connector;
passing a second, opposing end of the lanyard, and at least one fall-protection item that is connected to the second, opposing end of the lanyard, through the accessible opening of the soft, endless connector to hitch the soft, endless connector to a rigid member that defines at least a portion of the captive eye of the rigid fastener so that the soft, endless connector removably connects the rigid fastener to the first end of the lanyard.
